(19) United States
(12) Patent Application Publication
(10) Pub. No.: US 2009/0250922 A1
(43) Pub. Date: Oct. 8, 2009

(54) Tailpipe Adapter and Method of Use

(75) Inventors: David W. Rossman, Liberty Township, OH (US); Adam V.H. Mathis, Cincinnati, OH (US)

Correspondence Address: WOOD, HERRON & EVANS, LLP, 2700 CAREW TOWER, 441 VINE STREET, CINCINNATI, OH, 45202, US

(73) Assignee: ROSSMAN ENTERPRISES, INCORPORATED, Cincinnati, OH (US)

(21) Appl. No.: 12/061,891

(22) Filed: Apr. 3, 2008

(51) Int. Cl. F16L 25/00; B05B 15/06

(52) U.S. Cl. 285/24; 285/62; 239/289

(57) ABSTRACT

A method and apparatus is disclosed for removably coupling a sleeve of a vehicle exhaust extraction system to a vehicle tailpipe. This apparatus includes an adapter which is secured to the vehicle tailpipe with a removable collar. After the removable collar is tightened around the exterior of the adapter, the adapter is fixed to the vehicle tailpipe so the adapter moves with the vehicle. The collar is configured to mate with the adapter so it may quickly and easily separate from the adapter when the vehicle pulls away.

### FIELD OF THE INVENTION

This invention relates generally to vehicle exhaust extractions systems for emergency vehicles, such as a fire truck or ambulance. More particularly, this invention relates to an apparatus for attachment to a tailpipe of an emergency vehicle and the method of using such apparatus.

### BACKGROUND OF THE INVENTION

Emergency vehicles, such as fire trucks, create a challenge due to the nature of their use. A fire truck is usually backed into a firehouse garage bay and readied for the next emergency call. When an emergency call comes in, the fire truck must be started by one of the firefighters while he waits for everyone to get properly dressed and board the vehicle in their appropriate locations. During this time interval in which the engine is running, exhaust gases exit the tailpipe of the vehicle. Due to the closed nature of the fire bay, these exhaust gases must be vented outside the building to the atmosphere for health and safety reasons.

There are many known emergency vehicle exhaust extraction systems, many of which include a flexible hose which vents to the atmosphere at one end and at the other end is secured to an apparatus or adapter for securement to the tailpipe of the vehicle.

One known system utilizes magnets to removably secure an apparatus located at the end of the hose to the vehicle tailpipe. In such a system, the firefighters need not manually disconnect the hose assembly from the tailpipe. Rather instead, once the garage door to the fire bay is opened, the fire truck may merely exit the building, and the pulling force of the hose pulls the apparatus off the vehicle tailpipe once the vehicle has sufficiently exited the building. This system is disclosed in U.S. Pat. Nos. 5,609,298 and 5,927,759, which are both fully incorporated by reference herein.

To date, the exhaust pipes of such fire trucks have commonly been five inches in diameter. However, new diesel engine regulations have required the truck manufacturers to increase the diameter of the vehicle tailpipe; an end portion of the tailpipe is now as large as seven inches in diameter. Therefore, there is a need for an adapter which enables known exhaust extraction systems to couple to a larger diameter tailpipe.

### SUMMARY OF THE INVENTION

The apparatus of this invention which accomplishes these objectives and one aspect of this invention comprises an apparatus for joining a vehicle exhaust evacuation system to a vehicle tailpipe. The apparatus comprises: 1) an adapter for securement to a vehicle tailpipe and 2) a removable collar which is used to secure the adapter to the vehicle tailpipe.

The adapter comprises a generally cylindrical outer member and a generally cylindrical inner member having a common longitudinal center axis. The inner member is spaced from the outer member by a plurality of spacers secured to the inner and outer members. More specifically, four spacers are secured to the inner and outer members of the adapter and extend therebetween. A portion of the inner member extends outwardly beyond an outer edge of the outer member.

The removable collar is adapted to surround the outer member of the adapter which upon being tightened secures the adapter to the tailpipe.

In one embodiment, a plurality of alignment members are secured to an outer surface of the outer member. These alignment members are located and sized to be received inside corresponding slots in a sleeve of a vehicle exhaust evacuation system to properly align the sleeve of a vehicle exhaust evacuation system so that upon being subject to sufficient force, the sleeve pulls away from the adapter of the present invention.

In the practice of this invention, the adapter is secured to the vehicle tailpipe and travels with it. Therefore, when the vehicle pulls out of the firehouse or similar building, the adapter separates from the sleeve of the vehicle exhaust evacuation system and goes with the vehicle. In one embodiment, the adapter has three alignment members which function to prevent the adapter from extending too far into the sleeve of the vehicle exhaust evacuation system. These alignment members, which are sized and shaped to fit into slots in the sleeve of the vehicle exhaust evacuation system, further function to align the adapter and sleeve properly relative to each other to facilitate quick and easy separation when the vehicle pulls away from the building. These alignment members are welded or otherwise secured to the outer surface of the outer member of the adapter and extend outwardly beyond an outer edge of the outer member of the adapter. The present invention may be used with different sleeves of vehicle exhaust evacuation systems; it is not intended to be limited to sleeves having magnets on the inside thereof such as disclosed in U.S. Pat. Nos. 5,609,298 and 5,927,759. For example, another sleeve suitable for use with the present invention is a pneumatically inflatable sleeve lacking magnets. One advantage of the adapter of this invention is the ability to provide a suitable coupling which may be quickly and easily attached and then separated properly from an emergency vehicle exhaust tailpipe which the vehicle pulls away from the fire bay or building.

These and other objects and advantages of this invention will become more readily apparent from the following description of the drawings.

### DESCRIPTION OF THE DRAWINGS

FIG. 1 is a partially diagrammatic perspective view of an apparatus for joining a vehicle exhaust evacuation system to a vehicle tailpipe with portions of the vehicle shown in phantom.

FIG. 2 is disassembled view of the apparatus of FIG. 1;

FIG. 2A is disassembled view of an alternative embodiment of apparatus;

FIG. 3 is a view taken along the line 3-3 of FIG. 2;

FIG. 4 is a view taken along the line 4-4 of FIG. 2;

FIG. 5 is a perspective view of a portion of a vehicle exhaust evacuation system which comprises part of the present invention; and

FIG. 5A is a perspective view of a portion of a vehicle exhaust evacuation system according to an alternative embodiment.

### DETAILED DESCRIPTION OF THE INVENTION

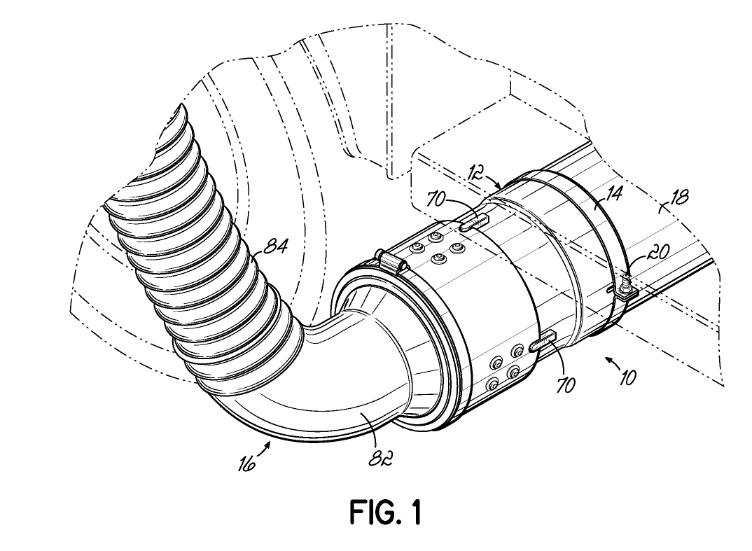

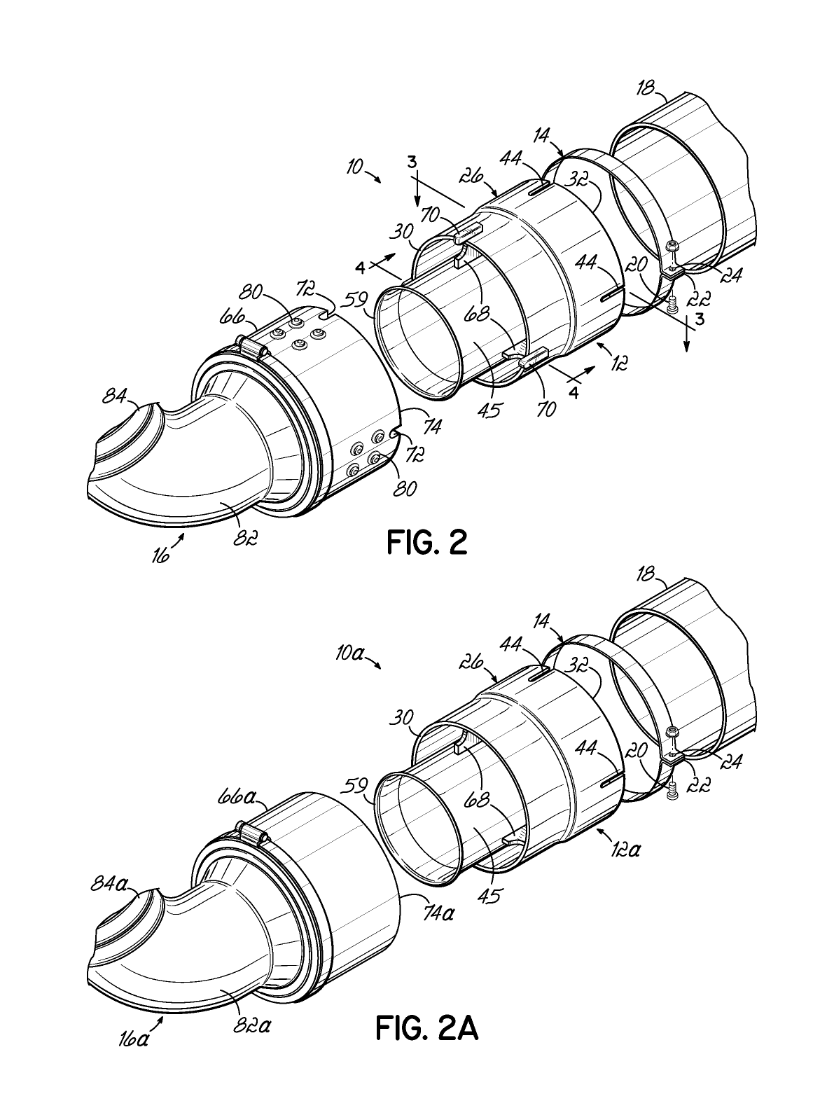

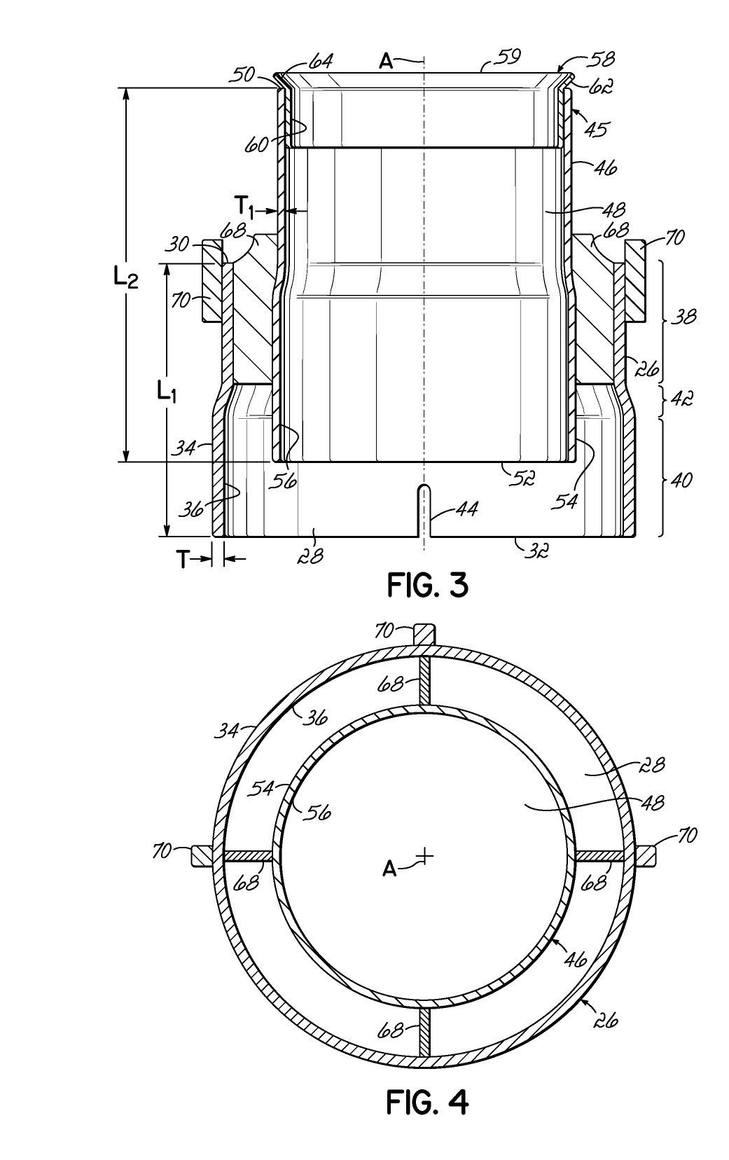

Referring to the drawings, the apparatus 10 of this invention comprises an adapter 12 and a collar 14 for joining a vehicle exhaust evacuation system 16 to a vehicle tailpipe 18 extending outwardly from a vehicle (shown in phantom in FIG. 1). The adapter 12 is shown secured to the vehicle tailpipe 18 in FIG. 1 and remains attached to the vehicle tailpipe 18 until one loosens the collar 14 by loosening the fastener 20 which functions to tighten and loosen the collar 14. As shown in FIGS. 2 and 3, the collar 14 is a one piece band of metal having two aligned flanges 22, each having a hole 24 therethrough. The fastener 20 extends through these holes 24 and may be used to tighten the collar 14 around the portion of the adapter 12 which surrounds the exterior of the vehicle tailpipe 18.

FIGS. 2-4 show the details of one embodiment of adapter 12. The adapter 12 comprises a generally cylindrical outer member 26 having an interior 28 and being open ended at both ends. This outer member 26 has an outer edge 30 (furthest away from tailpipe 18) and an inner edge 32, the linear distance between which defines a length L1 of the outer member 26 of the adapter 12. See FIG. 3. The outer member 26 has an outer surface 34 and an inner surface 36, the distance therebetween which defines the thickness T of the outer member 26 of the adapter 12. The outer member 26 of the adapter 12 has an outer portion 38 having a first inner diameter, an inner portion 40 of a second inner diameter larger than the first inner diameter and a neck portion 42 between the outer and inner portions 38, 40. Both outer and inner portions 38, 40, respectively have the same longitudinal central axis A. See FIGS. 3 and 4.

The inner diameter of the inner portion 40 of the outer member 26 of the adapter 12 is sized to fit over the vehicle tailpipe 18. A plurality of spaced slots 44 extend inwardly from the inner edge 32 of the outer member 26 of the adapter 12 and aid in fitting the outer member 26 of the adapter 12 and more particularly, the inner portion 40 of the outer member 26 of the adapter 12 over the vehicle tailpipe 18. Although FIG. 2 shows two slots 44 and FIG. 3 shows only one slot 44, the adapter 12 may have any number of slots 44 to aid in securing the inner portion 40 of the outer member 26 of the adapter 12 over the vehicle tailpipe 18.

The adapter 12 further comprises a generally cylindrical inner assembly 45 having an interior 48 and being open ended at both ends. This inner assembly 45 comprises a generally cylindrical inner member 46 and an end ring 58 secured together via welding or any other suitable means. In certain applications, the end ring 58 may be omitted, for example when a non-magnetized sleeve is being used.

The inner member 46 has an outer edge 50 (furthest away from tailpipe 18) and an inner edge 52 (shown in FIG. 3), the linear distance between which defines a length L2 of the inner member 46 of the adapter 12. The inner member 46 has an outer surface 54 and an inner surface 56, the distance therebetween which defines the thickness T1 of the inner member 46 of the adapter 12.

At its outer end, the end ring 58 comprises a cylindrical portion 60 and a flared portion 62 which is flared outwardly to create a flare 64 extending circumferentially outward away from the longitudinally extending central axis A of the adapter 12. The end ring 58 has an outer edge 59 and functions to aid in the release of the sleeve 66 from the adapter 12 in certain applications. The inner and outer members 46, 26 are secured together in an aligned manner to be coaxial, i.e. have the same central axis A.

The inner member 46 is spaced from the outer member 26 of the adapter 12 by four spacers 68 as shown in FIG. 4. The spacers 68 are each secured to the inner surface 36 of the outer member 26 and to the outer surface 54 of the inner member 46, preferably via welding, and extend therebetween.

As shown in FIG. 3, the length L2 of the inner member 46 is greater than the length L1 of the outer member 26. However, the inner and outer member 46, 26, respectively may be any desired length. As shown in FIG. 3, the inner edge 52 of the inner member 46 is inside the interior 28 of the outer member 26 and the outer edge 50 of the inner member 46 is outside the interior 28 of the outer member 26.

In one embodiment, the adapter 12 further comprises three alignment members 70 which are secured via welding to the outer surface 34 of the outer member 26, as shown in FIG. 4. Each of these alignment members 70 is located, sized and shaped to fit into one of the slots 72 extending inwardly from an edge 74 of the sleeve 66 of the vehicle exhaust extraction system 16. As shown in FIGS. 2 and 3, each of these alignment members 70 extends outwardly beyond the outer edge 30 of the outer member 26 of the adapter 12. Although three alignment members 70 are illustrated, the adapter 12 may have any number of alignment members at any desired locations.

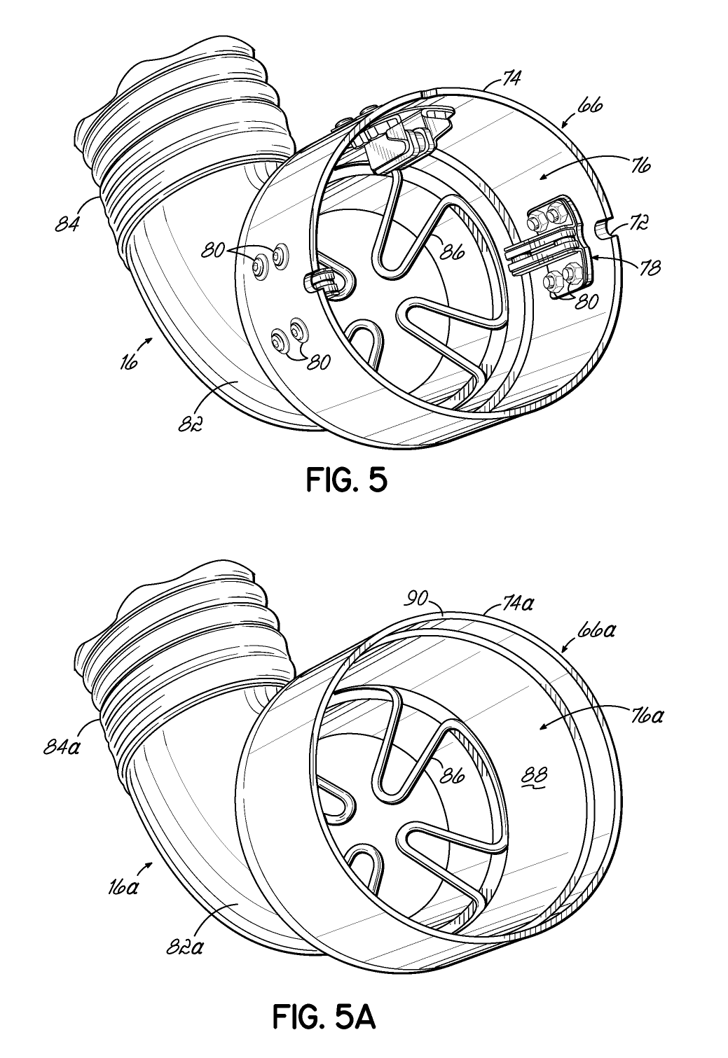

FIG. 5 illustrates the interior of sleeve 66 of one embodiment of the vehicle exhaust evacuation system 16. The sleeve 66 has an interior 76 with multiple magnet assemblies 78 (three being shown) secured with fasteners 80 to the sleeve 66. The vehicle exhaust evacuation system 16 further comprises a rigid pipe 82 and a flexible hose 84. As shown in FIG. 5, a stop 86 in the form of a wire formed into a clover shape is secured inside the pipe 82 and functions to prevent unwanted objects from being pulled into the hose 84.

FIGS. 2A and 5A illustrate an alternative embodiment of apparatus 10a. In this embodiment, the collar 14 is the same as in the embodiment shown in FIGS. 1-5 and described herein. For simplicity, the numbers of the elements remain the same. However, the adapter 12a and sleeve 66a of this embodiment are slightly different that the adapter 12 and sleeve 66 of the embodiment shown in FIGS. 1-5 and described herein. More particularly, the adapter 12a is otherwise identical to the adapter 12, but has no alignment members 70. The sleeve 66a of the vehicle exhaust evacuation system 16a has an interior 76 without multiple magnet assemblies. Instead this sleeve 66a has an inner member 88 and an outer member 90 between which air is introduced in a pneumatic operation, known in the industry. Sleeve 66a lacks any slots extending inwardly from the edge 74a of the outer member 90. The vehicle exhaust evacuation system 16a further comprises a rigid pipe 82a and a flexible hose 84a. As shown in FIG. 5A, a stop 86 in the form of a wire formed into a clover shape is secured inside the pipe 82a and functions to prevent unwanted objects from being pulled into the hose 84a.

While we have described only two embodiments of this invention, persons skilled in this art will appreciate changes and modifications which may be made without departing from the spirit of this invention.

We claim:

1. Apparatus for joining a vehicle exhaust evacuation system to a vehicle tailpipe, which apparatus comprises:
an adapter for securement to a vehicle tailpipe, said adapter comprising a generally cylindrical outer member and a generally cylindrical inner member, the inner member being spaced from the outer member by a plurality of spacers secured to the inner and outer members, a portion of said inner member extending outwardly beyond an outer edge of the outer member; and
a removable collar adapted to surround the outer member of the adapter to secure the adapter to the tailpipe.

2. The apparatus of claim 1 further comprising an end ring secured to the inner member.

3. The apparatus of claim 1 wherein said inner member is spaced from the outer member by four spacers.

4. The apparatus of claim 1 wherein said spacers are welded to the inner and outer members.

5. The apparatus of claim 1 wherein said outer member of said adapter has a length less than the length of the inner member of the adapter.

6. The apparatus of claim 1 further comprising alignment members secured to said outer member of said adapter sized and shaped to fit into slots in a sleeve of a vehicle exhaust evacuation system.

7. The apparatus of claim 6 wherein said alignment members are secured to an outer surface of said outer member of said adapter.

8. Apparatus for joining a vehicle exhaust evacuation system to a vehicle tailpipe, which apparatus comprises:
an adapter for securement to a vehicle tailpipe, said adapter comprising an outer member and an inner member, the inner member being spaced from the outer member by spacers secured to the inner and outer members, a portion of said inner member extending outwardly beyond an outer edge of the outer member and being adapted to fit inside a sleeve of a vehicle exhaust evacuation system, a portion of said outer member of said adapter having a plurality of spaced slots and being sized to surround a vehicle tailpipe; and
a removable collar adapted to surround the outer member of the adapter to secure the adapter to the tailpipe.

9. The apparatus of claim 8 further comprising alignment members secured to said outer member of said adapter sized and shaped to fit into slots in a sleeve of a vehicle exhaust evacuation system.

10. The apparatus of claim 9 wherein said alignment members are secured to an outer surface of said outer member of said adapter.

11. The apparatus of claim 10 further comprising three alignment members secured to said outer member of said adapter sized and shaped to fit into slots in a sleeve of the vehicle exhaust evacuation system.

12. In combination, a sleeve attached to the end of a vehicle exhaust evacuation system and an adapter for securing to a vehicle tailpipe, which combination comprises:
a sleeve of a vehicle exhaust evacuation system, said sleeve having a plurality of spaced slots extending inwardly from an edge thereof; and
an adapter for securement to a vehicle tailpipe, said adapter comprising an outer member and an inner member, the inner member being spaced from the outer member by spacers secured to the inner and outer members and extending therebetween, a portion of said inner member extending outwardly beyond an outer edge of the outer member and being adapted to fit inside said sleeve of said vehicle exhaust evacuation system, said outer member of said adapter having a plurality of alignment members adapted to fit into the spaced slots of the sleeve, wherein said adapter may be separated from said sleeve.

13. The combination of claim 12 further comprising a removable collar adapted to surround the outer member of the adapter to secure the adapter to the tailpipe.

14. The combination of claim 12 wherein said outer member of said adapter has a plurality of spaced slots and is sized to surround a vehicle tailpipe.

15. The combination of claim 12 wherein said inner member of said adapter has a flared end ring attached to said inner member.

16. The combination of claim 12 wherein said inner member of said adapter is spaced from the outer member of the adapter by four spacers.

17. The combination of claim 12 wherein said spacers of said adapter are welded to the inner and outer members.

18. The combination of claim 12 wherein said outer member of said adapter has a length less than the length of the inner member of the adapter.

19. The combination of claim 12 further comprising an end ring welded to the inner member of the adapter.

20. The combination of claim 19 wherein said end ring has a flared portion.
